(19) United States
(12) Patent Application Publication
(10) Pub. No.: US 2003/0016495 A1
(43) Pub. Date: Jan. 23, 2003

(54) Cooling unit including plurality of radiating fins and fan for sending air and electronic apparatus with the cooling unit mounted thereon

(76) Inventor: Takeshi Hongo, Sagamihara-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/190,522

(22) Filed: Jul. 9, 2002

(30) Foreign Application Priority Data
Jul. 9, 2001 (JP) 2001-208049

(51) Int. Cl. G06F 1/20

(52) U.S. Cl. 361/687; 361/683; 361/697

(57) ABSTRACT

A cooling unit including a heat sink and fan. The heat sink includes a base thermally connected to a heat generating component, and a plurality of radiating fins projecting from the base. The radiating fins are arranged at intervals, and extend along a flow direction of an air supplied from the fan. The radiating fins include a plurality of trenches cut toward the base in end portions on a side opposite to the base. The trenches are arranged at intervals in a longitudinal direction of the radiating fins.

### CROSS-REFERENCE TO RELATED APPLICATIONS

This application is based upon and claims the benefit of priority from the prior Japanese Patent Application No. 2001-208049, filed Jul. 9, 2001, the entire contents of which are incorporated herein by reference.

### BACKGROUND OF THE INVENTION

1. Field of the Invention

The present invention relates to a cooling unit which cools heat generating components such as a semiconductor package and an electronic apparatus on which the cooling unit is mounted.

2. Description of the Related Art

For microprocessors for use in electronic apparatuses such as a portable computer, a heat value has increased by the raising of a processing speed and the multiplying of functions. Therefore, a conventional electronic apparatus includes a cooling unit which cools the microprocessor. The cooling unit includes a heat sink thermally connected to the microprocessor, and an electromotive fan for sending air to the heat sink.

The heat sink includes an air path through which air supplied from the electromotive fan flows, and a plurality of radiating fins arranged in the air path. Known examples of the radiating fins include strip or columnar fins disclosed, for example, in “Jpn. Pat. Appln. KOKAI Publication No. 10-104375”, and flat-plate fins extending along a flow direction of air. The strip or columnar radiating fins are arranged in a matrix form, and air is unthreaded and flows between the radiating fins disposed adjacent to each other. The plate-shaped radiating fins are arranged at intervals in parallel to one another, and air straight flows between the radiating fins disposed adjacent to each other.

Additionally, since the strip or columnar radiating fins are independent of one another, a heat conduction area is small, and an increase of a temperature difference between a root portion and tip-end portion of the fin cannot be avoided. Therefore, a fin efficiency indicating radiating capabilities of the radiating fins is deteriorated. The fin efficiency represents a ratio of an actual heat value of the radiating fins to a heat value obtained by assuming that the entire temperature of the radiating fins is equal to the temperature of the root portion. The radiating capabilities of the radiating fins having a bad fin efficiency lower.

The flat-plate radiating fins extend along the flow direction of air. Therefore, the heat conduction area increases, and the fin efficiency increases as compared with the strip or columnar radiating fins. However, in the flat-plate radiating fins, since air flows along the radiating fins, the flow of air cannot positively be diffused. As a result, particularly when an airflow amount is small, an efficiency of heat exchange is deteriorated.

Therefore, in the conventional radiating fins, the heat of the microprocessor conducted to the heat sink cannot efficiently be released, and a problem occurs that a cooling capability of the microprocessor becomes insufficient.

### BRIEF SUMMARY OF THE INVENTION

An object of the present invention is to provide a cooling unit which can raise a radiating capability of a radiating fin, and can efficiently cool a heat generating component.

Another object of the present invention is to provide an electronic apparatus on which the cooling unit is mounted.

To achieve the above-described objects, according to a first aspect of the present invention, there is provided a cooling unit including a fan which supplies air; and a heat sink which receives the air supplied from the fan. The heat sink includes a base thermally connected to a heat generating component; and a plurality of radiating fins which project from the base, extend along a flow direction of the air, and are arranged at intervals. The radiating fins include a plurality of trenches cut toward the base in an end portion thereof on a side opposite to the base. The trenches are arranged at intervals in a longitudinal direction of the radiating fins.

According to the constitution, since the radiating fins extend in the flow direction of the air, a heat conduction area increases. Therefore, a temperature difference between the root portion of the radiating fin connected to the base and the end portion thereof decreases, and radiating capabilities of the radiating fins increase. Additionally, since the plurality of trenches are arranged in the end portion of the radiating fin, the tip-end portion is formed to have concaves/convexes. Therefore, the air passed between the radiating fins contact the concaves/convexes, and the flow of the air forms a turbulent flow in positions corresponding to the end portions of the radiating fins. Therefore, the air flows to uniformly contact the concaves/convexes in the end portions of the radiating fins, and heat exchange is efficiently performed between the air and radiating fins.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view of a portable computer according to a first embodiment of the present invention.

FIG. 2 is a sectional view of the portable computer showing a positional relation between a housing and a cooling unit in the first embodiment of the present invention.

FIG. 3 is a sectional view taken along a line F3-F3 of FIG. 2.

FIG. 4 is a perspective view of a heat sink showing shapes of radiating fins in the first embodiment of the present invention.

FIG. 5 is a side view of the heat sink showing the shapes of the radiating fins in the first embodiment of the present invention.

FIG. 6 is a perspective view of the heat sink showing the shapes of the radiating fins in a second embodiment of the present invention.

FIG. 7 is a side view of the heat sink showing the shapes of the radiating fins in a third embodiment of the present invention.

FIG. 8 is a side view of the heat sink showing the shapes of the radiating fins in a fourth embodiment of the present invention.

### DETAILED DESCRIPTION OF THE INVENTION

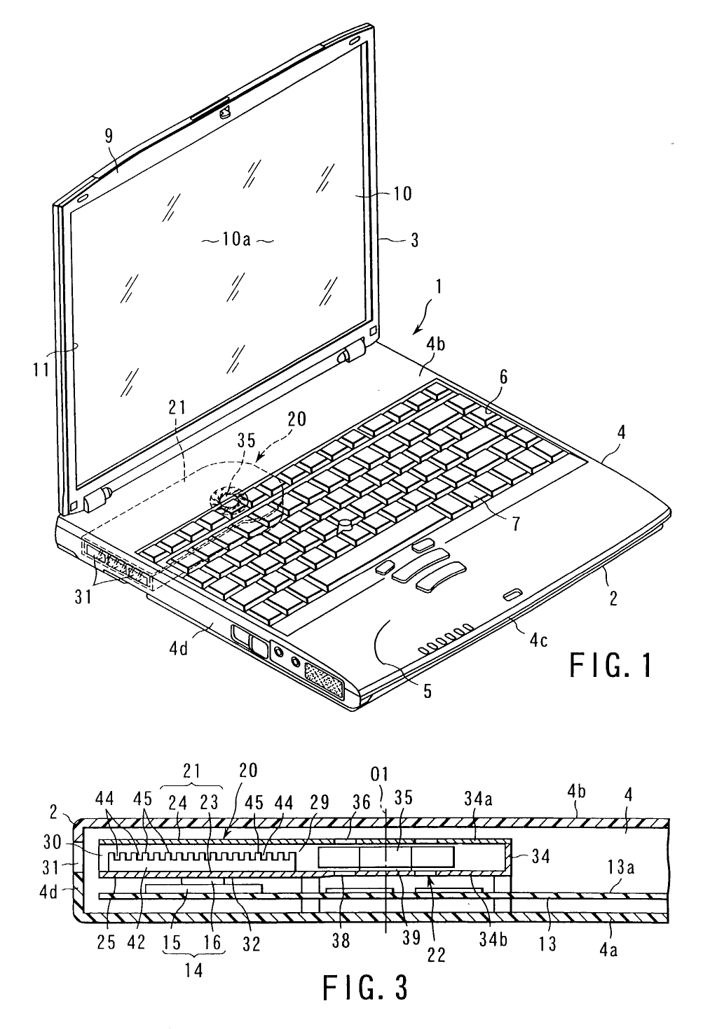

A first embodiment of the present invention will be described hereinafter with reference to FIGS. 1 to 6 applied to a portable computer.

FIG. 1 shows a portable computer 1 as an electronic apparatus. The portable computer 1 comprises a computer main body 2 and a display unit 3 supported by the computer main body 2.

The main body 2 includes a housing 4. The housing 4 has a flat box shape including a bottom wall 4a, upper wall 4b, front wall 4c, left and right side walls 4d, and rear wall 4e. The upper wall 4b of the housing 4 includes a palm rest 5 and keyboard attaching portion 6. The palm rest 5 is positioned in a front end of the housing 4. The keyboard attaching portion 6 is positioned behind the palm rest 5. A keyboard 7 is disposed in the keyboard attaching portion 6.

The display unit 3 includes a display housing 9 and a liquid crystal display panel 10 contained in the display housing 9. The display housing 9 is connected to a rear end of the housing 4 via a hinge (not shown) so that the housing can rotate. The liquid crystal display panel 10 has a display screen 10a for displaying an image. The display screen 10a is exposed to the outside via an opening 11 formed in a front surface of the display housing 9.

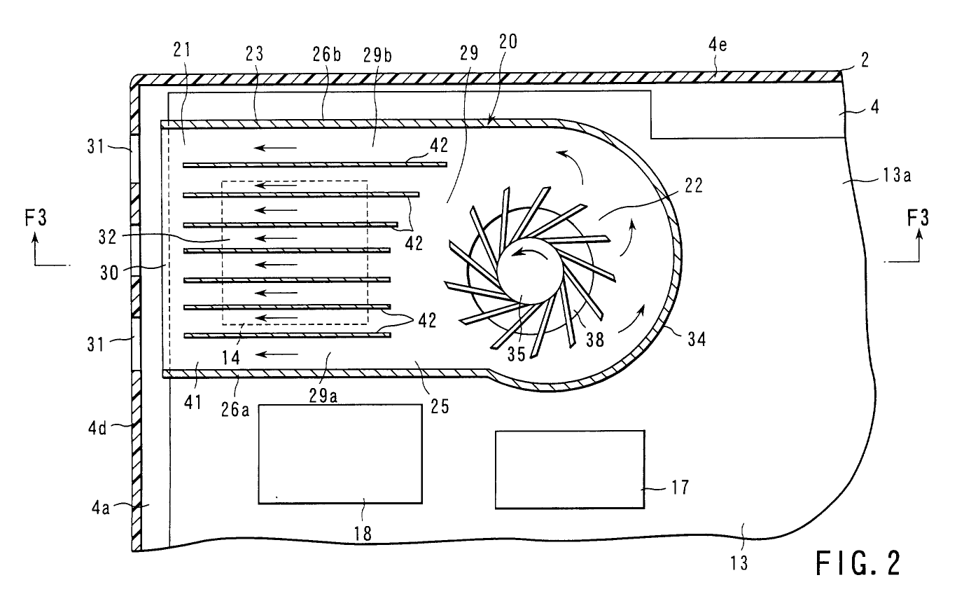

As shown in FIGS. 2 and 3, the housing 4 contains a printed wiring board 13. The printed wiring board 13 is disposed in parallel to the bottom wall 4a of the housing 4. The printed wiring board 13 has an upper surface 13a disposed opposite to the upper wall 4b of the housing 4 and the keyboard 7. A semiconductor package 14, power unit 17 and chip set 18 are mounted on the upper surface 13a of the printed wiring board 13.

The semiconductor package 14 constitutes a heat generating component, and is positioned in a left end of a rear portion of the housing 4. The semiconductor package 14 includes a base board 15, and an IC chip 16 soldered to an upper surface of the base board 15. The IC chip 16 has a very large amount of heat generated during an operation, and needs to be cooled in order to maintain a stable operation.

Furthermore, the housing 4 contains a cooling unit 20 which cools the semiconductor package 14. The cooling unit 20 includes a heat sink 21 and electromotive fan 22. The heat sink 21 and electromotive fan 22 are formed to be integral with each other, and positioned in a corner defined by the left side wall 4d and rear wall 4e of the housing 4.

The heat sink 21 is constituted of a metal material superior in heat conductivity, such as an aluminum alloy. The heat sink 21 has a flat box shape extending in a width direction of the housing 4. The heat sink 21 is constituted of a base 23 and top plate 24. The base 23 has a bottom plate 25, and side plates 26a and 26b rising from front and rear edges of the bottom plate 25. The top plate 24 is fixed over the upper ends of the side plates 26a and 26b, and disposed opposite to the bottom plate 25.

An air path 29 is formed between the base 23 and top plate 24. The air path 29 extends in the width direction of the housing 4, and has an outlet 30 in a downstream end thereof. The outlet 30 is disposed opposite to an exhaust port 31 formed in the left side wall 4d of the housing 4. Furthermore, the air path 29 includes a first air supplying region 29a extending along the front side plate 26a, and a second air supplying region 29b extending along the rear side plate 26b.

The base 23 of the heat sink 21 is fixed to the upper surface 13a of the printed wiring board 13. The bottom plate 25 of the base 23 is disposed opposite to the upper surface 13a of the printed wiring board 13. A lower surface of the bottom plate 25 forms a flat heat receiving section 32. The heat receiving section 32 is disposed in a position opposite to the air path 29. The heat receiving section 32 is thermally connected to the IC chip 16 of the semiconductor package 14.

As shown in FIGS. 2 to 4, the electromotive fan 22 includes a fan casing 34 and centrifugal impeller 35. The fan casing 34 is formed integrally with the heat sink 21, and positioned in an upstream end of the air path 29. The fan casing 34 has a hollow box shape, and includes an upper surface 34a and bottom surface 34b. The upper surface 34a is connected to the top plate 24 of the heat sink 21. The bottom surface 34b is connected to the base 23 of the heat sink 21.

The fan casing 34 includes first and second inlets 36 and 38. The first inlet 36 is opened in the upper surface 34a of the fan casing 34. The inlet 38 is opened in the bottom surface 34b of the fan casing 34. The second inlet 38 is positioned right under the first inlet 36.

The impeller 35 is contained in the fan casing 34 in a posture in which a rotation axial line O1 is vertically disposed. The impeller 35 is disposed between the first inlet 36 and second inlet 38, and positioned in the upstream end of the air path 29. The impeller 35 is rotated by a flat motor 39, when the temperature of the semiconductor package 14 reaches a predetermined value. When the impeller 35 rotates, the air in the housing 4 is sucked into the rotation center portion of the impeller 35 through the first and second inlets 36 and 38. The air is exhausted into the upstream end of the air path 29 from an outer peripheral portion of the impeller 35 by a centrifugal force.

According to the first embodiment, the impeller 35 rotates in a counterclockwise direction as shown by arrows in FIG. 2. Therefore, when the impeller 35 is viewed from a direction of the front side plate 26a of the base 23, the impeller 35 rotates in a direction apart from the outlet 30. Conversely, when the impeller 35 is viewed from the direction of the rear side plate 26b of the base 23, the impeller 35 rotates toward the outlet 30.

Therefore, much of the air exhausted from the outer peripheral portion of the impeller 35 is guided to the rear side plate 26b along the inner surface of the fan casing 34, and flows into the second air supplying region 29b. As a result, the amount of the air flowing through the second air supplying region 29b is larger than the amount of the air flowing through the first air supplying region 29a. Therefore, a deviation is generated in an airflow amount distribution of the air flowing through the air path 29.

As shown in FIGS. 3 to 5, the bottom plate 25 of the base 23 includes a flat guide surface 41. The guide surface 41 is exposed to the air path 29. A plurality of radiating fins 42 are formed integrally on the guide surface 41. The radiating fins 42 have elongated flat plate shapes which straight extend toward the outlet 30 from the outer peripheral portion of the impeller 35, and are positioned in the air path 29. These radiating fins 42 project upwards from the guide surface 41, and are arranged at intervals in parallel to one another in the air path 29.

Each radiating fins 42 includes root portions 43a connected to the base 23, and end portions 43b on a side opposite to the root portions 43a. The root portions 43a continuously extend toward the outlet 30 from the outer peripheral portion of the impeller 35. Upper edges of the end portions 43b are disposed opposite to the top plate 24.

Each radiating fins 42 includes a plurality of trenches 44 in the end portions 43b. The trenches 44 are straight cut toward each root portions 43a from the upper edge of the end portions 43b, and arranged at intervals in the longitudinal direction of the radiating fins 42. These trenches 44 have bottoms 44a. The bottom 44a of each trench 44 is positioned above the guide surface 41 by a size corresponding to a height of the root portion 43a. A height dimension hi to the guide surface 41 from the bottom 44a of each trench 44 is preferably h1=(0.3 to 0.9)H, in which H denotes an entire height dimension of the radiating fins 42. The height dimension h1 is equal in all the trenches 44. In other words, all the trenches 44 have an equal trench depth D.

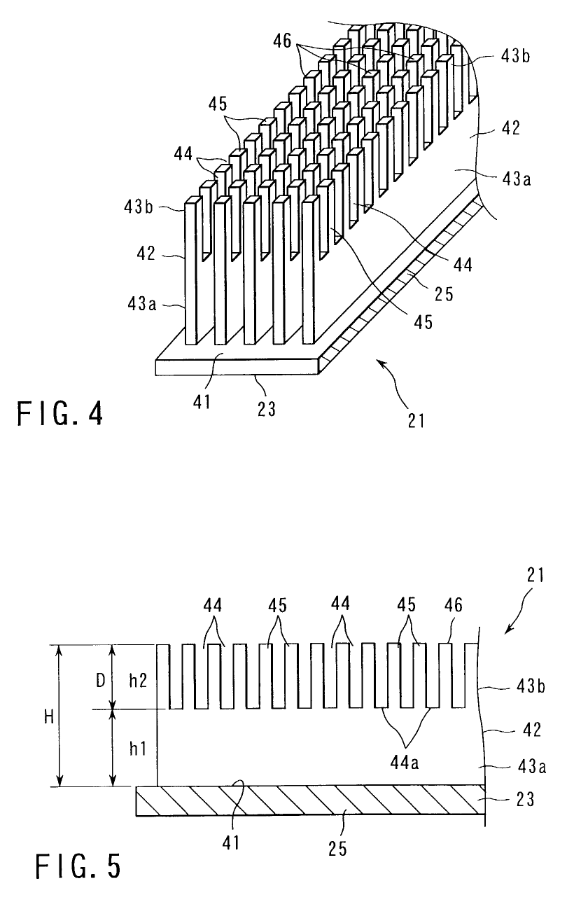

For the trenches 44, each of a plurality of projections 45 is formed between the trenches 44 disposed adjacent to each other. As shown in FIGS. 4 and 5, the projections 45 have strip shapes, and project upwards from the upper end of the root portion 43a. All the projections 45 have an equal projecting height h2. These projections 45 are arranged in one row at predetermined pitches in the longitudinal direction of the radiating fins 42. Therefore, the radiating fins 42 have a large number of concaves/convexes 46 in the tip-end portions 43b, and the concaves/convexes 46 extend over the entire length of the radiating fins 42.

In this constitution, the IC chip 16 of the semiconductor package 14 generates heat during an operation of the portable computer 1. The heat of the IC chip 16 is conducted to the heat receiving section 32 of the heat sink 21, and subsequently diffused in the base 23 and top plate 24 by heat conduction.

When the temperature of the semiconductor package 14 reaches the predetermined value, the impeller 35 of the electromotive fan 22 rotates. Thereby, the air inside the housing 4 is sucked into the rotation center portion of the impeller 35 through the first and second inlets 36 and 38 of the fan casing 34. The sucked air is exhausted to the upstream end of the air path 29 from the outer peripheral portion of the impeller 35 by a centrifugal force, and flows toward a downstream in the air path 29.

The air flowing through the air path 29 flows through the radiating fins 42 as shown by the arrows in FIG. 2, and cools the heat sink 21 which receives the heat of the IC chip 16 in this flow process. The heat of the IC chip 16 conducted to the heat sink 21 is taken away by heat exchange with the air. The air warmed by the heat exchange is exhausted to the outside of the housing 4 from the outlet 30 of the air path 29 through the exhaust port 31.

According to the above-described constitution, the air flowing through the air path 29 contacts the radiating fins 42, and takes away the heat of IC chip 16 conducted to the radiating fins 42. In this case, since the root portions 43a of the radiating fins 42 extend along the flow direction of the air, a heat conduction area is large. Therefore, the heat of the IC chip 16 conducted from the base 23 can efficiently be diffused in a broad range, and temperature distribution of each of the root portions 43a becomes equal. As a result, a fin efficiency indicating radiating capabilities of the radiating fins 42 increases.

Furthermore, since the trenches 44 and projections 45 are alternately arranged in the end portion 43b of each radiating fin 42, the end portion 43b has a shape including a large number of concaves/convexes 46. Therefore, the air in the air path 29 is unthreaded and flows through the concaves/convexes 46, and this flow of air results in a turbulent flow. In other words, the end portions 43b of the radiating fins 42 form a generating region of the turbulent flow in positions apart from the root portions 43a in the air path 29. The air flowing through the generating region forms the turbulent flow diffused to uniformly contact the concaves/convexes 46 of the radiating fins 42. As a result, heat exchange is efficiently performed between the air and the end portions 43b of the radiating fins 42.

As described above, the heat of the IC chip 16 conducted to the radiating fins 42 can efficiently be released from both the root portions 43a and the end portions 43b of the radiating fins 42. Therefore, a cooling capability of the semiconductor package 14 is enhanced. Even in a use mode in which the semiconductor package 14 is driven at a maximum capability, an operation environment temperature of the semiconductor package 14 can appropriately be kept.

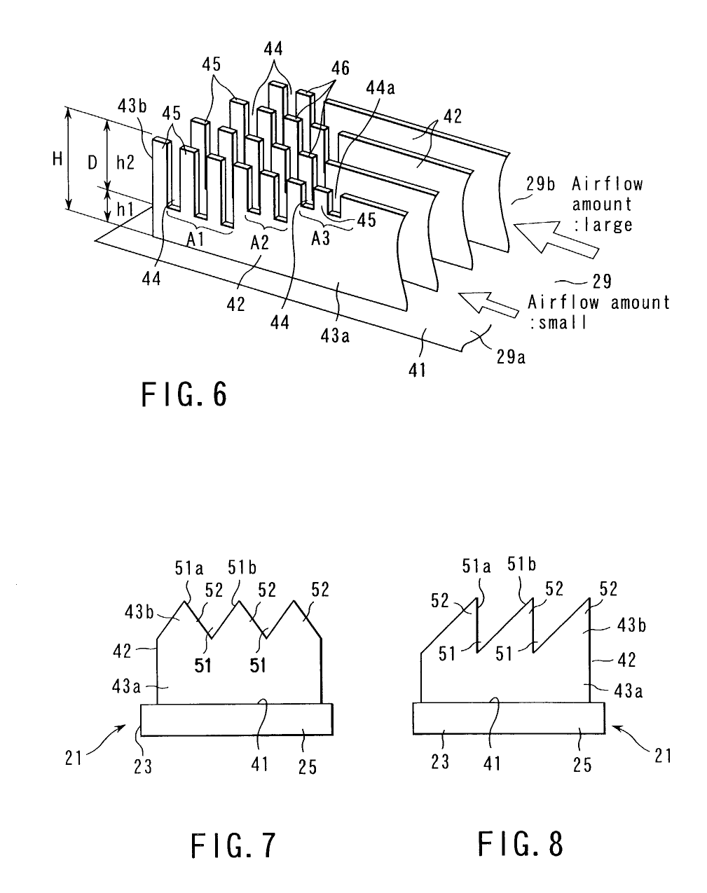

Additionally, the present invention is not limited to the first embodiment. FIG. 6 shows a second embodiment of the present invention.

The second embodiment is different from the first embodiment in that the shapes of the end portions 43b of the radiating fins 42 are varied in accordance with the airflow amount distribution of the air flowing through the air path 29. Other basic constitutions of the cooling unit 20 are similar to those of the first embodiment. Therefore, in the second embodiment, the same constituting components as those of the first embodiment are denoted with the same reference numerals, and the description thereof is omitted.

As shown in FIG. 6, the radiating fins 42 are positioned in the first and second air supplying regions 29a and 29b of the air path 29. The radiating fin 42 positioned in the first air supplying region 29a having a small airflow amount includes a plurality of trenches 44 and projections 45 over a constant range extending to an upstream from a downstream end of the end portion 43b.

The trenches 44 are divided into three groups A1, A2 and A3 which are different from one another in a depth dimension D to each bottom 44a. The trenches 44 of the group A1 are positioned in the downstream end of the radiating fin 42. The trenches 44 of the group A2 are positioned on an upstream side of the trenches 44 of the group A1, and the trenches 44 of the group A3 are positioned on the upstream side of the trenches 44 of the group A2. The depth dimensions D of the trenches 44 of these groups A1 to A3 change so as to decrease in stages toward the upstream group from the downstream group of the radiating fin 42. In other words, the height dimension hi to the guide surface 41 of the base 23 from the bottoms 44a of the trenches 44 in each group changes so as to increase in stages toward the upstream group from the downstream group of the radiating fin 42.

Therefore, the concaves/convexes 46 of the radiating fin 42 positioned in the first air supplying region 29a change in the shapes toward the upstream from the downstream of the radiating fin 42.

Furthermore, the numbers of trenches 44 and projections 45 of the radiating fin 42 decrease in stages toward the radiating fin 42 of the second air supplying region 29b from the radiating fin 42 of the first air supplying region 29a. Therefore, the radiating fin 42 positioned in the second air supplying region 29b having a large airflow amount includes the trenches 44 and projections 45 only in a remarkably narrow range of the downstream end of the end portion 43b. The depth dimension D of each trench 44 of the radiating fin 42 positioned in the second air supplying region 29b is set to be equal to that of each trench 44 of the group A1 having a largest depth dimension D.

According to the constitution, the radiating fin 42 positioned in the first air supplying region 29a with the small airflow amount has more trenches 44 and convex portions 45 than the radiating fin 42 positioned in the second air supplying region 29b. Therefore, the turbulent flow can positively be generated in the air flowing through the first air supplying region 29a, and the efficiency of the heat exchange between the radiating fins 42 and the air can be enhanced.

On the other hand, according to the radiating fin 42 positioned in the second air supplying region 29b having the large airflow amount, the trenches 44 and projections 45 exist only in a small range of the downstream end of the radiating fin 42. Therefore, the air smoothly flows along the radiating fin 42 without generating the turbulent flow. Therefore, circulation resistance of the air flowing through the second air supplying region 29b is suppressed, and the efficiency of the heat exchange between the radiating fins 42 and the air is enhanced.

As a result, the radiating capabilities of the radiating fins 42 can appropriately be set in accordance with the airflow amount distribution in the air path 29, and the semiconductor package 14 can efficiently be cooled.

FIG. 7 shows a third embodiment of the present invention.

The third embodiment is different from the first embodiment in the shapes of trenches 51 and projections 52 of the radiating fin 42. Each trench 51 of the third embodiment includes a pair of edges 51a and 51b disposed opposite to each other. These edges 51a and 51b are inclined in directions approaching each other toward the base 23 from the upper edge of the end portion 43b of the radiating fin 42. Therefore, the projections 52 formed between the trenches 51 disposed adjacent to each other is pointed toward the upper edge of the end portion 43b of the radiating fin 42.

FIG. 8 shows a fourth embodiment of the present invention.

The fourth embodiment is a development of the third embodiment. As shown in FIG. 8, one edge 51a of the trench 51 vertically rises, and the other edge 51b is inclined in a direction approaching one edge 51a toward the base 23 from the upper edge of the end portion 43b of the radiating fin 42. Therefore, the fourth embodiment is different from the third embodiment in the shapes of the trenches 51 and projections 52.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A cooling unit which cools a heat generating component, comprising:
a fan which supplies air; and
a heat sink which receives the air supplied from the fan, the heat sink including: a base thermally connected to the heat generating component; and a plurality of radiating fins which project from the base, extend along a flow direction of the air, are arranged at intervals, and include a plurality of trenches cut toward the base in end portions on a side opposite to the base, wherein the trenches are arranged at intervals in a longitudinal direction of the radiating fins.

2. The cooling unit according to claim 1, wherein the heat sink includes an air path through which the air from the fan flows, and the radiating fins are positioned in the air path.

3. The cooling unit according to claim 1, wherein the trenches include bottoms, and height dimensions to the base from the bottoms are equal to one another.

4. The cooling unit according to claim 2, wherein the trenches include bottoms, and are divided into a plurality of groups different from one another in a depth dimension to the bottoms, and the depth dimension of the trenches of the groups changes so as to decrease toward the group positioned in an upstream of the air path from the group positioned in a downstream of the air path.

5. The cooling unit according to claim 4, wherein a height dimension to the base from the bottom of the trench changes so as to increase toward the trench in an upstream of the radiating fin from the trench in a downstream of the radiating fin.

6. A cooling unit which cools a heat generating component, comprising:
a fan which supplies air; and
a heat sink which receives the air supplied from the fan, the heat sink including: a base thermally connected to the heat generating component; and a plurality of radiating fins which project from the base, extend along a flow direction of the air, are arranged at intervals, and include a plurality of projections projecting in a direction apart from the base in end portions on a side opposite to the base, wherein the projections are arranged at intervals in a longitudinal direction of the radiating fins.

7. The cooling unit according to claim 6, wherein projecting heights of the projections are equal to one another.

8. The cooling unit according to claim 6, wherein the heat sink includes an air path through which the air from the fan flows, and the radiating fins are positioned in the air path.

9. The cooling unit according to claim 8, wherein projecting heights of the projections change so as to decrease toward an upstream from a downstream of the radiating fins.

10. A cooling unit which cools a heat generating component, comprising:
a fan which supplies air; and
a heat sink thermally connected to the heat generating component, the heat sink including: an air path through which the air supplied from the fan flows; and a plurality of radiating fins which are arranged at intervals in the air path, extend along a flow direction of the air, and include tip-end portions including concaves/convexes.

11. An electronic apparatus comprising:
a housing including a heat generating component;
a fan which is contained in the housing and supplies air; and
a heat sink which receives the air supplied from the fan, the heat sink including: a base thermally connected to the heat generating component; and a plurality of radiating fins which project from the base, extend along a flow direction of the air, are arranged at intervals, and include a plurality of trenches cut toward the base in end portions on a side opposite to the base, wherein the trenches are arranged at intervals in a longitudinal direction of the radiating fins.

12. The electronic apparatus according to claim 11, wherein the heat sink includes an air path through which the air from the fan flows, and the radiating fins are arranged in the air path.

13. An electronic apparatus comprising:
a housing including a heat generating component;
a heat sink thermally connected to the heat generating component, the heat sink including: an air path; and a plurality of radiating fins which extend along the air path, are arranged at intervals, and include tip-end portions including concaves/convexes; and
a fan which supplies air to the air path of the heat sink.
